(19) United States
(12) Patent Application Publication
(10) Pub. No.: US 2009/0074977 A1
(43) Pub. Date: Mar. 19, 2009

(54) Process and Device for Preparing Coated Plasterboards

(76) Inventors: Juergen Martin, Kleinlangheim (DE); Gosbert Grebner, Albertshofen (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 11/885,897

(22) PCT Filed: Mar. 17, 2006
(86) PCT No.: PCT/EP06/60815

§ 371 Date: Apr. 28, 2008

(30) Foreign Application Priority Data
Mar. 17, 2005 (EP) 05102105.3

(51) Int. Cl. B05D 3/02; B05C 11/00

(52) U.S. Cl. 427/376.1; 118/58

(57) ABSTRACT

A process for preparing a coated plasterboard, comprising the following steps in the following order in one production cycle:
a) forming a plasterboard;
b) drying the plasterboard in a drying device;
c) coating the plasterboard by spraying with a coating agent after said drying;
d) stacking the plasterboards;
   wherein there is a period of time of less than 60 seconds between the end of the coating and the stacking of the plasterboards.

### BACKGROUND

1. Field of the Disclosure

The present disclosure relates to a process and device for preparing coated plasterboards.

2. Discussion of the Background Art

Gypsum-based construction boards, referred to as plasterboards in the following, are employed in dry construction for the preparation of floors, walls and ceilings. The corresponding boards are manufactured industrially.

For gypsum plasterboards, plaster of Paris is typically mixed with water and various additives to form a slurry, which is then cast onto a cardboard sheet. Then, a second cardboard sheet is applied, so that the gypsum is enclosed by the two cardboard sheets before setting. The strand is then passed over a setting belt. During the time required for this, the plaster of Paris in the board core will set to form calcium sulfate dihydrate. The cured strand is separated into plates by a suitable cutting device. This is followed by a drying process in which the excess water is removed. Instead of cardboard, alternative products, such as glass-fiber webs or textile webs, may also be employed for coating.

An alternative thereof are gypsum fiber boards, which are typically prepared from gypsum and cellulose fibers. For this purpose, plaster of Paris and cellulose fibers are mixed intimately. An amount of water sufficient for the setting of the plaster of Paris is added to this mixture. This so-called green plate is then compressed under pressure. After the setting on the setting section and separation, the boards are dried. Corresponding gypsum fiber boards are characterized, in particular, by their high mechanical loadability.

After the boards have been built in, the joints between the boards are usually filled, the walls or ceilings obtained are primed and provided with paint or wallpaper. Painting or applying wallpaper is referred to as decoration. Frequently, primers or wallpaper changing paints are previously applied.

Especially with perforated or slotted boards, the edges of the boards are mostly primed manually.

Because these corresponding works must be performed manually on site, they are time-consuming and expensive.

Various attempts have been made to include the pretreatment and/or decoration in the industrial manufacture (prefabrication).

Thus, EP 0 777 800 B1 describes the use of a cardboard with a cover layer that is ready for decoration without pretreatment.

EP 1 076 137 A2 relates to a lining paper that is given a decorative surface finish by printing the liner before it is used in the manufacture of a gypsum plasterboard.

It has been found disadvantageous to employ such special cardboard materials, because they add to the costs on the one hand and in part hinder the drying process of the gypsum core on the other. In the preparation of gypsum plasterboards, it is essential that the cardboard layers employed have a high moisture permeability to allow a uniform drying of the gypsum core while ensuring sufficient adhesion of the cardboard to the gypsum core.

The above mentioned processes of the prior art are not applicable to gypsum fiber boards, because these do not include any exterior cardboard or web layers.

US 2003/0113572 describes a special coating composition for a plasterboard containing a binder, soybean protein and two or more pigments. Although this document generally describes that the coating may be effected before or after the rack drier, it is preferred that the coating composition is applied before the rack drier. Examinations of the composition described there have shown that it exhibits drying times of clearly more than 10 min and dries well only if employed before the rack drier.

WO 99/10151 relates to a material for the preparation of materials from phosphate-based inorganic foams. On page 7, it is described that a corresponding process is not applicable to plasterboards.

### SUMMARY

It is the object of the present disclosure to develop a process and a device with which the disadvantages of the prior art can be overcome.

Surprisingly, it has been found that it is possible to coat plasterboards immediately after drying without disturbing the usual course of the process thereby.

A coating within the meaning of this application includes the application of both primers and means for decoration, for example, color paints.

Plasterboards are dried in a continuous preparation process, and after passing the drying station, they are bordered, stacked and packaged and/or provided with strapping as a transportation lock. Destacking stacked boards for further processing generally is a tedious process that would reduce the production performance of corresponding plants.

Therefore, the disclosure relates to a process for preparing a coated plasterboard, comprising the following steps in the following order in one production cycle:

a) forming a plasterboard;
b) drying the plasterboard in a drying device;
c) coating the plasterboard by spraying with a coating agent after said drying;
d) stacking the plasterboards;
wherein there is a period of time of less than 60 seconds between the end of the coating and the stacking of the plasterboards.

Thus, according to the disclosure, the step of coating the plasterboards is included in the preparation process and immediately follows the drying process. The board, while still warm, is sprayed with a coating agent. The residual heat of the board surprisingly accelerates the drying of the coating agent to such an extent that the coating agent has sufficiently dried by the time of stacking the plasterboards to avoid sticking together of the stacked boards.

The step of forming the plasterboard includes the necessary steps for preparing the plasterboard until it arrives at the drier. These may include steps of setting or separating.

According to the disclosure, there is no stacking or conveying to another working station between the drying of the plasterboard and the stacking, but the coating immediately follows the drying. Subsequently, the plasterboard is stacked with further boards to form a plasterboard stack.

The process according to the disclosure is suitable for both gypsum plasterboards and gypsum fiber boards.

Depending on the width of the board, one or more spraying nozzles are employed for spraying, wherein the spraying zones may overlap. Typically, when the plasterboards are prepared, several boards are prepared in parallel and leave the drying device together and simultaneously. In this case, they are coated at the same time by a correspondingly larger number of spraying nozzles. Particularly suitable spraying nozzles are wide jet spraying nozzles. There may be employed, for example, airless spraying systems (pressure spraying systems) or systems in which the spraying is effected by a gas, for example air, so-called two-component nozzles or airless dual nozzles (combination of airless and air-assisted atomization).

Systems of this kind are commercially available. They work at pressures of from 1 to 100 bar, in part up to 150 bar.

In one embodiment of the disclosure, the nozzles do not spray at the board surface at an angle of 90°, but slightly obliquely, the nozzles being arranged to spray in or against the direction of transportation of the boards.

In a preferred embodiment, the angle between the direction of spraying of the nozzles and the board surface is from 20° to 80°, more preferably from 30° to 60°.

The skilled person can readily establish how the optimum angle or the optimum distance between the spraying device and the board will be. Typical distances are within a range of from 10 to 60 cm, more preferably within a range of from 20 to 40 cm.

The coating agent preferably has a water content in order to avoid emissions from evaporating solvents etc. Preferred water contents are at least 30% by weight, more preferably at least 40% by weight, and even more preferred water contents are at least 80% by weight or at least 95% by weight, especially with primers.

Preferably, the coating material is applied in an amount of from 20 to 100 g/m² (based on the dry weight of the coating agent).

According to the disclosure, between the end of the drying step and the stacking of the plasterboards, there is only a short period of time that includes the coating step according to the disclosure. Between the end of the coating and the stacking of the plasterboard, there is typically a period of less than 60 seconds, even more preferably less than 40 seconds and most preferably less than 30 seconds. The shorter the times between the coating and the stacking, the smaller the plant may be designed in the zone after drying. The time mentioned is the time after which the coated side of the coated plasterboard prepared comes into contact with another surface, typically by laying another plasterboard on it during stacking.

A wide variety of coating agents may be employed. There may be employed, for example, water-repellent coating agents, water-barrier coating agents, wallpaper changing primers, color paints, impregnating agents, anti-skidding agents, liquid films and/or strength-increasing agents.

The simultaneous or successive spraying with two or more coating agents is also possible.

Typically, gypsum plasterboards have a Cobb value of about 100 to 200 g/m² upon two hours of exposure according to ASTM C473-87a. Further preferred values are within a range of from 130 to 160 g/m². Since the gypsum core has already dried at the time of coating, it is not relevant whether the coating employed hinders the exit of water from the surface. Therefore, monomers that will subsequently polymerize may also be employed for the coating. Agents that strengthen the surface, such as one-component resins, may also be employed.

In one embodiment, another drying step is provided after the coating in order to accelerate drying. For example, drying by infrared irradiation, hot air or the like may be employed.

In another embodiment, such a further drying step is not provided.

Since the surface is coated directly in the case of gypsum plasterboards, cardboard materials that are of inferior quality and have a less uniform appearance may also be employed in principle. The coating provides the board with a high-quality appearance all the same. In principle, it is also conceivable to employ different cardboard qualities for the boards, so that only the side that is to be coated is prepared from a lesser quality cardboard.

The thus obtained boards can be further processed in the usual way, for example, by perforating, bending, slitting or bordering.

This subsequent processing step may also be integrated into the preparation process and be performed before the stacking of the plasterboards. However, it is also possible to convey the boards to another station after stacking and to perform further working steps there. Of course, it is also possible to integrate part of the postprocessing into the preparation process and to perform further postprocessing steps later. Typical postprocessing steps serve for the preparation of beveled edges, shiplap edges etc.

In one embodiment, the plasterboards are coated on at least one edge after drying, but before stacking. This is reasonable, in particular, if the edges were treated, for example, by beveling, forming shiplap edges or V cutting. For this purpose, coating composition is applied to this region of the edge. This increases the strength of joints. A corresponding processing step may follow directly after the processing of the edge by means of bundlers or cutting devices.

In another embodiment, it is also possible that the stacking may be followed by a treatment step in which edges of the stacked plasterboards are coated by spraying with a coating composition, especially by a primer. This can also increase the strength of edges.

The plasterboards are advantageously applied together with a filler composition having an identical color with that of the coating for filling the joints formed between the boards, so that a uniform appearance of the walls is achieved already after the filling of the joints between the boards.

In a preferred embodiment, the coating is effected synchronously with the transport of the boards, i.e., the spraying is interrupted as soon as a board leaves the spraying zone and recommences when the next board reaches the spraying means.

Particularly suitable devices for performing the process are described in the following:

The device according to the disclosure comprises a drying means for drying one and especially more plasterboards. As a drying means, a rack drier may be provided, for example. Upstream from the drying means, a plasterboard forming means serving for preparing the plasterboard may be provided. Downstream from the drying means, there is a conveying means by which the plasterboards are conveyed to a stacking means after drying. By means of the stacking means, the plasterboards are stacked on pallets or the like, for example. According to the disclosure, immediately after the drying means, a coating means is provided for coating the plasterboards by which the plasterboards, while still warm, are coated, said coating being performed, in particular, as described above by means of the process according to the disclosure. Thus, the coating is preferably effected during the transport of the plasterboard from the drying means to the stacking means.

In order to avoid contamination of conveying elements of the conveying means, such as a conveying belt, during the coating step, which is preferably effected by spraying, a deflection means is preferably provided. By the deflection means, the conveying element is arranged or deflected at a distance from the plasterboard in the coating zone. This has the advantage that the risk of contaminating the conveying elements or the conveying belt is significantly reduced. Further, there is a possibility to provide a receptor or capturing means in the zone between the plasterboard and the deflected conveying element. Thus, for example, coating material that has been sprayed beside the plasterboard can optionally be taken up by the receptor means, which may be a trough, and does not get onto the conveying belt.

The device according to the disclosure is preferably further embodied as described above by means of the process according to the disclosure.

### BRIEF DESCRIPTION OF THE DRAWINGS

In the following, the disclosure is further illustrated by means of a preferred embodiment with reference to the accompanying drawings, wherein:

FIG. 1 shows a schematic lateral view of a first preferred embodiment of the disclosure;

FIG. 2 shows a schematic lateral view of a second preferred embodiment of the disclosure; and

FIG. 3 shows a schematic enlarged view of the coating zone.

### DETAILED DESCRIPTION OF THE PREFERRED EMBODIMENT

In a drying means 10, which is a rack drier in the example shown, several plasterboards 12 are provided. By a conveying means 14, which can be adjusted in height, for example, by a hydraulic system 16 in the direction of an arrow 18, the plasterboards 12 can be taken from the drying means 10 and transported via a second conveying means 20 to a stacking means (not shown), by which the plasterboards 12 are stacked, for example, on pallets.

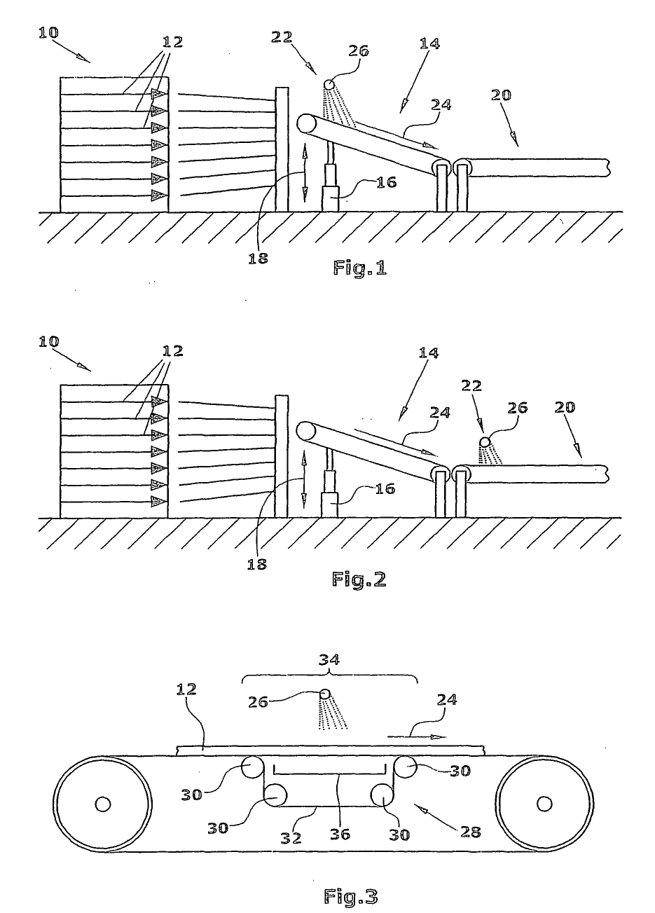

In a first preferred embodiment of the disclosure (FIG. 1), a coating means 22 is provided in the zone of the pivotable conveying means 14. The coating means 22 has spraying nozzles 26 arranged transversely to a direction of transport 24. By means of the spraying nozzles 26, the plasterboards 12 are coated while they are being transported by the conveying means 14 into the direction of conveying 24.

Several drying means can be juxtaposed, so that the conveying means 14 can transport several juxtaposed plasterboards simultaneously, which can be coated simultaneously by accordingly provided spraying nozzles.

In the first preferred embodiment (FIG. 1), the coating means 22 is pivotable together with the conveying means 14, so that the distance between the spraying nozzles 26 and the plasterboards 12 remains constant independently of the position of the conveying means 14.

In a second preferred embodiment (FIG. 2), the coating means 22 is provided, not in the zone of the pivotable conveying means 14, but in the zone of the subsequent conveying means 20. This has the advantage that pivoting the coating means together with the conveying means 14 is not required.

In the zone of the coating means 22, a deflection means 28 (FIG. 3) may be provided. In the example shown, the deflection means has four deflection pulleys 30, so that a conveying element 32, such as a conveying belt, is at a distance from the plasterboard 12 in a coating zone 34. For capturing excess coating material, a receptor means 36, such as a trough, is preferably provided between the plasterboard 12 and the conveying element 32 in the coating zone 34.

The disclosure is further illustrated by the following Examples.

### EXAMPLE 1

A gypsum plasterboard was prepared on a plant in the usual way by continuously applying a gypsum slurry to a cardboard sheet and covering it with a second cardboard sheet. After the gypsum core has set, the boards are separated and transferred into a rack drier. After the drying, a coating was effected with a device according to FIG. 2 in which two wide jet nozzles were employed. As the coating agent, a water-based paint containing inorganic pigments, binders, emulsifiers and further correcting agents and stabilizers was applied. The coating weight was 65 g/m². Due to the residual heat of the boards, the coating composition dried within 20 seconds to such an extent that the coated boards could be stacked directly on top of one another with a usual device.

### EXAMPLE 2

The same procedure as in Example 1 was used, but after the removing from the drier and the coating, two neighboring edges of the plasterboards were beveled, and the boards were subsequently stacked. The plasterboard stack was subjected to a further coating step at a further station by coating the edges.

What is claimed is:

1. A process for preparing a coated plasterboard, comprising the following steps in the following order in one production cycle:
a) forming a plasterboard;
b) drying the plasterboard in a drying device;
c) coating the plasterboard by spraying with a coating agent after said drying;
d) stacking the plasterboards;
wherein there is a period of time of less than 60 seconds between the end of the coating and the stacking of the plasterboards.

2. The process according to claim 1, wherein said plasterboard is a gypsum plasterboard or a gypsum fiber board.

3. The process according to claim 1, wherein said spraying is effected by one or more spraying nozzles, preferably wide jet spraying nozzles.

4. The process according to claim 1, wherein the angle between the direction of spraying and the board surface is from 20° to 80°.

5. The process according to claim 1, wherein said coating agent has a water content of at least 30% by weight.

6. The process according to claim 1, wherein there is a period of less than 40 seconds between the end of the coating and the stacking of the plasterboards.

7. The process according to claim 1, wherein said plasterboard is subsequently further processed by at least one process selected from the group consisting of: perforating, bending, slitting and bordering.

8. The process according to claim 1, wherein said coating agent is at least one coating selected from the group consisting of: water-repellent coating agents, water-barrier coating agents, wallpaper changing primers, color paints, impregnating agents, anti-skidding agents, liquid films, strength-increasing agents, bactericides and fungicides.

9. The process according to claim 1, wherein said only a partial area of the plasterboard is coated in step c).

10. The process according to claim 9, wherein said partial area comprises one or more edges of said plasterboard.

11. The process according to claim 1, wherein said plasterboard is additionally coated on at least one edge by spraying with a coating agent.

12. The process according to claim 1, wherein at least one edge of the stacked plasterboards is coated by spraying with a coating agent after stacking.

13. A process for preparing an at least partially coated plasterboard, comprising the following steps in the following order in one production cycle:
a) forming a plasterboard;
b) drying the plasterboard in a drying device;
c) stacking the plasterboard;
d) coating at least one edge of the plasterboard by spraying with a coating agent.

14. A device for preparing a coated plasterboard by the process according to claim 1, comprising:
a dryer for drying a plasterboard; and
downstream from the dryer, a conveyor for conveying the plasterboard to a stacker;
wherein
immediately downstream from the dryer, a coating means for coating the plasterboard while still warm is provided.

15. The device according to claim 14, wherein said coating means is arranged in such a way that the coating is effected during the conveying of the plasterboard by the conveyor.

16. The device according to claim 14, further comprising a deflector, arranged opposite to said coating means, for keeping a conveying element of the conveyor at a distance from the plasterboard in the coating zone.

17. The device according to claim 16, further comprising a receptor for receiving excess coating material, provided between the plasterboard and the conveying element in the coating zone.

18. The device according to claim 14, wherein said coating means has spraying nozzles arranged at an angle of from 20° to 80° with respect to the surface of the plasterboard.
